(19) United States
(12) Patent Application Publication
(10) Pub. No.: US 2018/0081969 A1
(43) Pub. Date: Mar. 22, 2018

(54) METHOD AND SYSTEM FOR DATA PROCESSING TO PREDICT DOMAIN KNOWLEDGE OF USER FOR CONTENT RECOMMENDATION

(71) Applicant: XEROX CORPORATION, Norwalk, CT (US)

(72) Inventors: Vivek Harikrishnan Ramalingam, Trichy (IN); Prince Gerald Albert, Chennai (IN); David R. Vandervort, Walworth, NY (US)

(21) Appl. No.: 15/270,379

(22) Filed: Sep. 20, 2016

(51) Int. Cl. G06F 17/30

(52) U.S. Cl. CPC G06F 17/30864; G06F 17/30477; G06F 17/30598; G06F 17/3053

(57) ABSTRACT

The disclosed embodiments illustrate methods and systems for data processing to predict domain knowledge of a user for content recommendation. The method includes extracting a set of features from user data based on at least a domain-of-interest. The method further includes categorizing each feature in each set of the extracted set of features into one of a plurality of categories. The method further includes determining a domain literacy weight of the user for each category of the plurality of categories based on at least an average weight associated with each set of the extracted set of features in each category. The method further includes predicting the domain knowledge of the user based on at least the determined domain literacy weight associated with each category. The predicted domain knowledge is further utilized for the content recommendation to the user.

### TECHNICAL FIELD

The presently disclosed embodiments are related, in general, to a data processing system. More particularly, the presently disclosed embodiments are related to a method and a system for processing data to predict domain knowledge of a user for content recommendation.

### BACKGROUND

With the proliferation of advanced multimedia devices and applications in the market, there has been a significant rise in targeting users with specific content associated with the products and/or services. The delivery of such targeted content may help an entity (e.g., a manufacturer or a distributor) to create awareness about the products and/or services among the users. Further, the delivery of such targeted content to the users may accelerate the growth and expansion of the entity. The users may also be benefited with such delivery of the targeted content as it keeps on updating the users with latest trends in the products and/or services, and associated offers, promos, and coupons.

However, with ever increasing competition among the entities, there have been a significant increase of the targeted content being delivered to the users. Such overall increment in the delivery of the targeted content may lower down impact of one targeted content with respect to others. Further, such increment may lower down the interest level of the users in the targeted content. Hence, the entity may not be able to utilize the idea of the targeted content in an efficient and effective manner. Existing practices typically involve delivery of the targeted content based on user data, such as social media data, of the users extracted from public platforms, such as social media platforms (e.g., Facebook®). However, such existing practices lack incorporation of current knowledge of the users about the content associated with the products and/or services. The current knowledge of the users may be derived based on a series of tests or surveys. However, the users may not be willing to take up the series of different tests or surveys for different domains, as it may consume a lot of time and effort of the users. Therefore, there is a need for a method and a system that can enhance an effective distribution of the targeted content to the users.

Further, limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there is provided a method for data processing to predict domain knowledge of a user for content recommendation. The method includes receiving, by a transceiver at a computing server, a request from a requestor-computing device, associated with a requestor, over a communication network. The received request comprises at least information about a domain-of-interest of the requestor. The method further includes extracting, by a feature extracting processor at the computing server, a set of features from user data, extracted from a storage device based on at least the received request, based on at least the domain-of-interest. The method further includes categorizing, by a feature categorizing processor at the computing server, each feature in each set of the extracted set of features into one of a plurality of categories based on at least a weight associated with each feature in each set of the extracted set of features. The method further includes determining, by a processor at the computing server, a domain literacy weight of the user for each category of the plurality of categories based on at least an average weight associated with each set of the extracted set of features in each category The method further includes predicting, by the processor, the domain knowledge of the user based on at least the determined domain literacy weight associated with each category. The predicted domain knowledge is further utilized for the content recommendation to the user.

According to embodiments illustrated herein, there is provided a system for data processing to predict domain knowledge of a user for content recommendation. The system includes a transceiver that is configured to receive a request from a requestor-computing device, associated with a requestor, over a communication network. The received request comprises at least information about a domain-of-interest of the requestor. The system further includes a feature extracting processor that is configured to extract a set of features from user data, extracted from a storage device based on at least the received request, based on at least the domain-of-interest. The system further includes a feature categorizing processor that is configured to categorize each feature in each set of the extracted set of features into one of a plurality of categories based on at least a weight associated with each feature in each set of the extracted set of features. The system further includes a processor that is configured to determine a domain literacy weight of the user for each category of the plurality of categories based on at least an average weight associated with each set of the extracted set of features in each category. The processor is further configured to predict the domain knowledge of the user based on at least the determined domain literacy weight associated with each category. The predicted domain knowledge is further utilized for the content recommendation to the user.

According to embodiment illustrated herein, there is provided a computer program product for use with a computer. The computer program product includes a non-transitory computer readable medium. The non-transitory computer readable medium stores a computer program code for data processing to predict domain knowledge of a user for content recommendation. The computer program code is executable by one or more processors to receive a request from a requestor-computing device, associated with a requestor, over a communication network. The received request comprises at least information about a domain-of-interest of the requestor. The computer program code is further executable by the one or more processors to extract a set of features from user data, extracted from a storage device based on at least the received request, based on at least the domain-of-interest. The computer program code is further executable by the one or more processors to categorize each feature in each set of the extracted set of features into one of a plurality of categories based on at least a weight associated with each feature in each set of the extracted set of features. The computer program code is further executable by the one or more processors to determine a domain literacy weight of the user for each category of the plurality of categories based on at least an average weight associated with each set of the extracted set of features in each category. The computer program code is further executable by the one or more processors to predict the domain knowledge of the user based on at least the determined domain literacy weight associated with each category. The predicted domain knowledge is further utilized for the content recommendation to the user.

### BRIEF DESCRIPTION OF DRAWINGS

The accompanying drawings illustrate the various embodiments of systems, methods, and other aspects of the disclosure. Any person having ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment in which various embodiments can be implemented, in accordance with at least one embodiment;

FIG. 2 is a block diagram that illustrates a system for data processing to predict domain knowledge of a user for content recommendation, in accordance with at least one embodiment; and

FIG. 3 is a flowchart that illustrates a method for data processing to predict domain knowledge of a user for content recommendation, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

### Definitions

The following terms shall have, for the purposes of this application, the meanings set forth below.

A “computing device” refers to a computer, a device (that includes one or more processors/microcontrollers and/or any other electronic components), or a system (that performs one or more operations according to one or more sets of programming instructions, code, or algorithms) associated with an entity. The entity may correspond to an individual or an organization. In one example, the individual (e.g., an administrator in the organization) may utilize the computing device to transmit a request to a computing server. In another exemplary scenario, the individual (e.g., a customer) may utilize the computing device to view targeted content recommended by the organization or a personnel, such as the administrator, in the organization. Examples of the computing device may include, but are not limited to, a desktop computer, a laptop, a personal digital assistant (PDA), a mobile device, a smartphone, and a tablet computer (e.g., iPad® and Samsung Galaxy Tab®).

A “social media platform” refers to a communication medium through which one or more registered users interact with each other. Further, the one or more registered users may post, share, like, or dislike one or more messages, images, videos, and/or the like on one or more social media platforms. Examples of the one or more social media platforms include, but are not limited to, social networking websites (e.g., Facebook®, LinkedIn®, Twitter®, Instagram®, Google+®, and so forth), web-blogs, web-forums, community portals, online communities, or online interest groups.

A “web search engine” is a platform that may facilitate a user to search for information on World Wide Web. The user may input a query, such as a keyword based query or a language based query, on the web search engine, such as Google®, Yahoo®, or Bing®, to search for the information. The information may be a mix web pages, images, videos, and other types of files.

A “requestor” refers to an individual who is associated with an entity, such as an organization. For example, the requestor may correspond to an administrator of the organization, who may be interested to figure out a domain knowledge of one or more customers. In another example, the requestor may correspond to a service provider, who provides services, such as a delivery of targeted content, to the one or more customers.

A “user” refers to an individual (e.g., a customer), who is a member of one or more social media platforms. In an embodiment, the user may be registered with a social media platform to become the member of the social media platform. During registration, the user provides information, such as name, gender, location, age, education, profession, one or more images, interests/hobbies, and so forth. In an embodiment, the user may further utilize the one or more social media platforms to communicate with one or more other users. Further, the user may utilize the one or more social media platforms to post, share, like, or dislike one or more messages associated with one or more products and/or services on the one or more social media platforms. Further, the user may utilize one or more web browsing services, such as Google®, Yahoo®, and Bing®, to search for the one or more products and/or services.

“User data” refers to data of a user. The user data may comprise at least social media data and browsing data of the user. In an embodiment, the social media data refers to data such as one or more messages (handwritten or typed), images, videos, and/or the like, that may have been posted, shared, liked, and/or disliked by the user about one or more products and/or services on one or more social media platforms. In an embodiment, the social media data may further comprise data pertaining to one or more replies, likes, and/or dislikes provided by the user on one or more messages, images, videos, and/or the like that are associated with one or more other users, or vice-versa. Further, the social media data may comprise profile information of the user on the social media platforms. In an embodiment, the browsing data refers to data that may have been generated based on one or more queries for one or more products and/or services by the user on one or more web browsing services, such as Google®, Yahoo®, and Bing®.

A “message” refers to a series of words, phrases, sentences, emoticons, and/or the like, that may be posted, shared, liked, or disliked by a user on various platforms, such as social media platforms or web search engines. For example, the user may post one or more messages for sharing one or more recommendations, reviews, opinions, or issues about one or more products and/or services.

A “domain knowledge” of a user refers to a degree of awareness of the user in a particular domain, for example, an industry, a product, a service, a subject, a concept, and/or the like. The higher value of degree of awareness of the user in a particular domain may infer a higher value of degree of understanding of the user for one or more new concepts in the particular domain, as the user is aware about the pre-requisite concepts of the one or more new concepts.

A “request” refers to a query raised by a requestor to a computing server to determine a domain knowledge of one or more users (i.e., one or more customers) in one or more domains-of-interest. In an embodiment, the request may comprise information about the one or more domains-of-interest. The request may further comprise at least one or more of, but is not limited to, a preference of the requestor for one or more sets of features extracted from user data, one or more preference weights corresponding to the preference, a pre-defined threshold range associated with each of a plurality of categories, a pre-defined time duration, and one or more pre-defined threshold values.

A “feature” refers to a characteristic or attribute that may be representative of a like, dislike, domain knowledge, interest, demographic data, profile data, proficiency, and so on of a user. The feature may be utilized to distinguish the characteristic of the user with the characteristic of one or more other users.

A “set of features” refers to a set of characteristics that may be extracted from user data comprising at least social media data and browsing data of the user. In an embodiment, the set of features may comprise one or more sets of features. Examples of the one or more sets of features may include, but are not limited to, a set of keyword features, a set of interest features, a set of profile features, and a set of proficiency features. In an embodiment, the set of keyword features may comprise one or more keywords, associated with a domain-of-interest requested by a requestor, in the user data. In an embodiment, the set of interest features may comprise attributes, such as likes, dislikes, most visits, shares, links available in posted messages, profile information, and/or preferences, of the user in the user data. In an embodiment, the set of profile features may comprise a count of friends, a count of followers, and a count of followings on one or more social media platforms. In an embodiment, the set of proficiency features may comprise information, such as profession, specialization, paper publications, patents filed, of the user.

A “category” refers to a type, a group, or a class of domain literacy. In an embodiment, each of a plurality of categories may be defined based on at least a threshold range (i.e., a lower threshold value and an upper threshold value) defined by an individual, such as a requestor. In an embodiment, a sum of all lower threshold values (or all upper threshold values) associated with the plurality of categories should be “1.” In an embodiment, the plurality of categories may comprise at least a first category, a second category, and a third category. In an embodiment, the first category may correspond to a low literacy category. In an embodiment, the second category may correspond to a medium literacy category. In an embodiment, the third category may correspond to a high literacy category.

A “domain dictionary” refers to a repository of features associated with a domain that has been defined by an individual, such as a requestor or a subject matter expert. The repository of features comprises at least a set of pre-defined keywords, a set of pre-defined interests, a set of pre-defined profiles, and a set of pre-defined proficiencies. Further, the domain dictionary comprises a pre-defined weight for each feature in the repository of features.

A “domain literacy weight” refers to a numerical value that may define a degree of knowledge of a user in a particular domain. In an embodiment, the domain literacy weight of the user for a category may be determined based on at least an average weight associated with each set of an extracted set of features in the category.

An “average” refers to a mathematical operation that may be performed on a set of numbers to obtain a single number. An average may correspond to an arithmetic mean, geometric mean, harmonic mean, quadratic mean, contra harmonic mean, median, and mode. The average may further correspond to a rolling average, weighted average, and/or the like.

A “user interface (UI)” refers to an interface that may facilitate an individual to interact with an associated computing device, such as a computer, a laptop, or a smartphone. The individual may utilize various input via various devices, such as keypad, mouse, joystick, a touch-sensitive medium (e.g., a touch-screen or touch sensitive pad), voice recognition system, gestures recognition system, face recognition system, and so forth, to interact with the UI. Hereinafter, the term “UI” is interchangeably referred to as “GUI.”

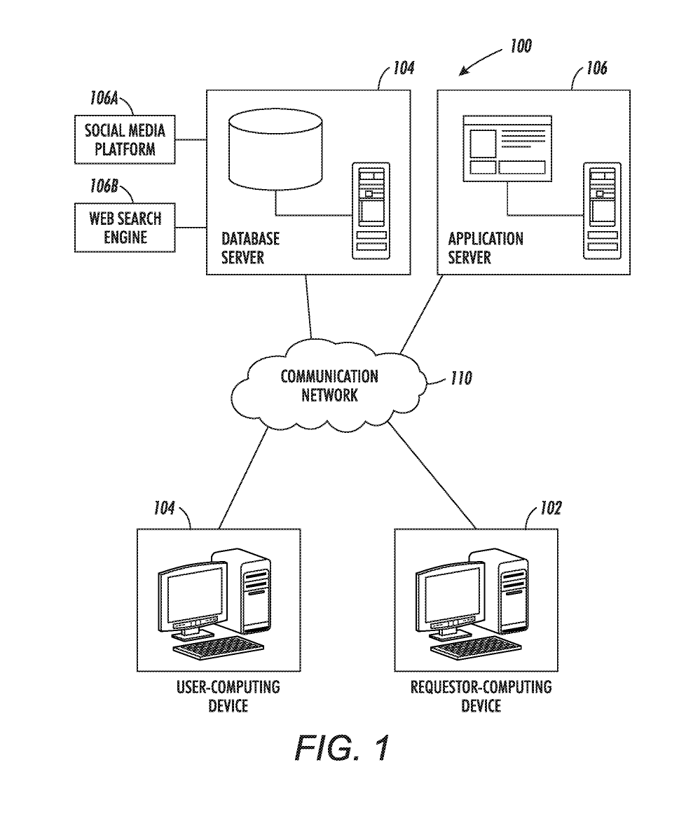

FIG. 1 is a block diagram of a system environment in which various embodiments of a method and a system for data processing to predict domain knowledge of a user for content recommendation may be implemented. With reference to FIG. 1, there is shown a system environment 100 that includes a requestor-computing device 102, a user-computing device 104, a database server 106, and an application server 108. The requestor-computing device 102, the user-computing device 104, the database server 106, and the application server 108 are communicatively coupled with each other over one or more communication networks, such as a communication network 110. The system environment 100 may further include a social media platform 106A and a web search engine 106B communicatively coupled with the database server 106. For simplicity, FIG. 1 shows one requestor-computing device, such as the requestor-computing device 102, one user-computing device, such as the user-computing device 104, one database server, such as the database server 106, and one application server, such as the application server 108. However, it will be apparent to a person having ordinary skill in the art that the disclosed embodiments may also be implemented using multiple requestor-computing devices, multiple user-computing devices, multiple database servers, and multiple application servers, without deviating from the scope of the disclosure.

The requestor-computing device 102 may refer to a computing device (associated with a requestor) that may be communicatively coupled to the communication network 110. The requestor may correspond to an individual, for example, an administrator in an organization or a content provider, who may be interested to determine a domain knowledge of a customer in one or more domains. In an embodiment, the requestor may utilize the requestor-computing device 102 to transmit a request to a computing server, such as the database server 106 or the application server 108, over the communication network 110. The transmitted request may comprise at least information about a domain-of-interest of the requestor. The requestor may further utilize the requestor-computing device 102 to define various parameters that may be required for processing user data to predict the domain knowledge of a user. For example, the requestor may utilize the requestor-computing device 102 to define one or more of, but not limited to, a plurality of categories, a threshold range associated with each of the plurality of categories, a preference for one or more sets of features, one or more preference weights corresponding to each preference, a pre-defined time duration, and one or more pre-defined threshold values.

The requestor-computing device 102 may include one or more processors in communication with one or more memory units. Further, in an embodiment, the one or more processors may be operable to execute one or more sets of computer-readable code, instructions, programs, or algorithms, stored in the one or more memory units, to perform one or more operations. In an embodiment, the requestor may utilize the requestor-computing device 102 to communicate with the user-computing device 104, the database server 106, or the application server 108, via the communication network 110.

The requestor-computing device 102 may further include a display screen that may be configured to display one or more GUIs rendered by the application server 108. For example, the application server 108 may render a GUI displaying the domain knowledge of customers in a geographical area. Base on the domain knowledge of the customers in the geographical area, the requestor may transmit a query to the application server 108 to render the content recommendation on computing devices associated with the customers.

Examples of the requestor-computing device 102 may include, but are not limited to, a personal computer, a laptop, a PDA, a mobile device, a tablet, or any other computing devices.

The user-computing device 104 may refer to a computing device (associated with the user) that may be communicatively coupled to the communication network 110. The user may correspond to an individual (e.g., a customer), who may be a recipient of the content recommendation. The user-computing device 104 may include one or more processors and one or more memory units. The one or more memory units may include computer-readable codes, instructions, or programs that are executable by the one or more processors to perform one or more operations.

In an embodiment, the user may utilize the user-computing device 104 to connect with one or more social media platforms, such as the social media platform 106A. Prior to the connection, the user may connect the user-computing device 104 over a network, such as the communication network 110. Thereafter, the user may open a web browser, such as a Mozilla Firefox web browser. Thereafter, the user may launch the one or more social media platforms, such as Facebook®, LinkedIn®, Twitter®, and/or Instagram®, on the user-computing device 104. In another embodiment, the user may launch the one or more social media platforms, such as Facebook®, LinkedIn®, Twitter®, and/or Instagram®, on the user-computing device 104 by using a web application installed on the user-computing device 104. Further, the user may utilize one or more input devices associated with the user-computing device 104 to input login credentials (e.g., user identifier and password). Based on the validation of the login credentials, the user may view his/her social media profile and related information on the user-computing device 104. Further, the user may utilize the one or more input devices to update his/her social media profile information. Further, the user may utilize the one or more input devices to post or share social media data (i.e., one or more messages, one or more images, one or more videos, and/or the like) on the one or more social media platforms. Further, in an embodiment, the user may utilize the one or more input devices, communicatively coupled with the user-computing device 104, to share, like, or dislike the social media data that are posted by one or more other users. Further, in an embodiment, the user may utilize one or more web browsing services, installed at the user-computing device 104, to search for one or more products and/or services. For example, the user may input a query, such as a keyword based query or a language based query, on one or more web search engines, such as Google®, Yahoo®, or ®, to search for the information associated with the one or more products and/or services. The information (i.e., browsing data) may correspond to web pages, images, videos, and other such types of files.

The user-computing device 104 may further include a display screen that may be configured to display one or more GUIs rendered by the application server 108. For example, the application server 108 may render a GUI displaying the content recommendation. The content recommendation may comprise at least a recommendation of the one or more products and/or services associated with the domain-of-interest. The content recommendation may further comprise at least one or more offers, promos, coupons, or discounts associated with the one or more products and/or services.

The user-computing device 104 may correspond to various types of computing devices, such as, but not limited to, a desktop computer, a laptop, a PDA, a mobile device, a smartphone, or a tablet computer (e.g., iPad® and Samsung Galaxy Tab.

The database server 106 may refer to a computing device or a storage device that may be communicatively coupled to the communication network 110. In an embodiment, the database server 106 may be configured to perform one or more database operations. Examples of the one or more database operations may include receiving/transmitting one or more queries, request, user data, or content from/to one or more computing devices, such as the requestor-computing device 102, the user-computing device 104, or the application server 108. The one or more database operations may further include processing and storing the one or more queries, request, user data, or content.

Further, in an embodiment, the database server 106 may be communicatively coupled with the one or more social media platforms, such as the social media platform 106A. The database server 106 may be further communicatively coupled with the one or more web search engines, such as the web search engine 106B. In an embodiment, the database server 106 may receive a query from the requestor-computing device 102 or the application server 108. The query may correspond to the extraction of the user data from the social media platform 106A and the web search engine 106B. Based on the received request, the database server 106 may extract the social media data the browsing data of the user from the social media platform 106A and the web search engine 106B, respectively, that constitute the user data. Thereafter, the database server 106 may store the extracted user data. Further, in an embodiment, the database server 106 may transmit the user data to the application server 108 over the communication network 110.

Further, in an embodiment, the database server 106 may store one or more sets of instructions, code, scripts, or programs that may be retrieved by the application server 108 to perform one or more operations. For querying the database server 106, one or more querying languages, such as, but not limited to, SQL, QUEL, and DMX, may be utilized. In an embodiment, the database server 106 may be realized through various technologies such as, but not limited to, Microsoft® SQL Server, Oracle®, IBM DB2®, Microsoft Access®, PostgreSQL®, MySQL® and SQLite®, MongoDB®, and/or the like.

The application server 108 may refer to a computing device or a software framework hosting an application or a software service that may be communicatively coupled to the communication network 110. In an embodiment, the application server 108 may be implemented to execute procedures, such as, but not limited to, the one or more sets of programs, instructions, code, routines, or scripts stored in one or more memory units for supporting the hosted application or the software service. In an embodiment, the hosted application or the software service may be configured to perform the one or more operations of the application server 108.

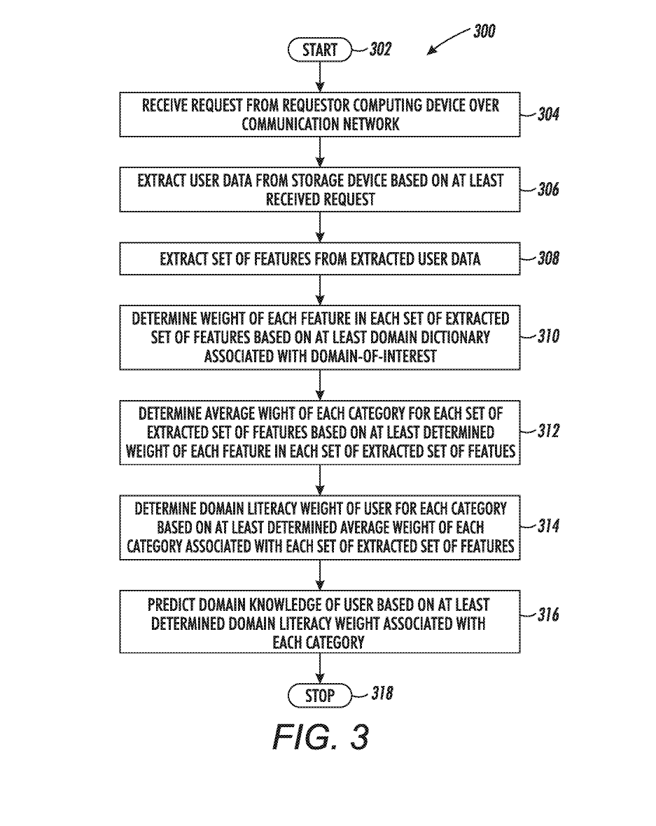

In an embodiment, the application server 108 may be configured to receive the request from the requestor-computing device 102 over the communication network 110. The request comprises at least the information about the domain-of-interest of the requestor. Further, based on the received request, the application server 108 may transmit the query to a storage device, such as the database server 106, to extract the user data of the user. Thereafter, the application server 108 may receive the extracted user data, comprising at least one of the social media data and the browsing data of the user, from the database server 106 over the communication network 110. Further, in an embodiment, the application server 108 may be configured to extract a set of features from the received user data based on at least the domain-of-interest of the requestor in the received request and a domain dictionary associated with the domain-of-interest. The extraction of the set of features has been explained later in detail in conjunction with FIG. 3.

Further, in an embodiment, the application server 108 may be configured to determine a weight, associated with each feature in each set of the extracted set of features, based on at least the domain dictionary associated with the domain-of-interest. The determination of the weight of each feature has been explained later in detail in conjunction with FIG. 3. Based on the determined weight associated with each feature in each set of the extracted set of features, in an embodiment, the application server 108 may be configured to categorize each feature in each set of the extracted set of features into one of a plurality of categories. The categorization of each feature in each set of the extracted set of features into one of the plurality of categories has been explained later in detail in conjunction with FIG. 3. Further, in an embodiment, the application server 108 may be configured to determine an average weight associated with each set of the extracted set of features in each category. The average weight is determined based on at least the determined weight of each feature in each set of the extracted set of features associated with each category. The determination of the average weight has been explained later in detail in conjunction with FIG. 3.

Further, in an embodiment, the application server 108 may be configured to determine a domain literacy weight of the user for each category. The domain literacy weight of the user for each category is determined based on the at least the determined average weight associated with each set of the extracted set of features in each category. The determination of the domain literacy weight has been explained later in detail in conjunction with FIG. 3. Further, in an embodiment, the application server 108 may be configured to predict the domain knowledge of the user based on at least the determined domain literacy weight of the user in each category. The prediction of the domain knowledge of the user has been explained later in detail in conjunction with FIG. 3. Further, in an embodiment, the application server 108 may utilize the predicted domain knowledge of the user for the content recommendation. The content recommendation may comprise a recommendation of the one or more products and/or services associated with the domain-of-interest. The content recommendation may further comprise at least one or more offers, promos, coupons, or discounts associated with the one or more products and/or services.

The application server 108 may be realized through various types of application servers such as, but not limited to, a Java application server, a .NET framework application server, a Base4 application server, a PHP framework application server, or any other application server framework.

A person having ordinary skill in the art will understand that the scope of the disclosure is not limited to the database server 106 as a separate entity. In an embodiment, the one or more functionalities of the database server 106 may be integrated into the application server 108, or vice-versa, without deviating from the scope of the disclosure.

A person having ordinary skill in the art will understand that the scope of the disclosure is not limited to the requestor-computing device 102 as a separate entity. In an embodiment, the one or more functionalities of the requestor-computing device 102 may be integrated into the application server 108, or vice-versa, without deviating from the scope of the disclosure.

The communication network 110 may include a medium through which one or more devices, such as the requestor-computing device 102 and the user-computing device 104, and one or more servers, such as the database server 106, and the application server 108, may communicate with each other. Examples of the communication network 110 may include, but are not limited to, the Internet, a cloud network, a Wireless Fidelity (Wi-Fi) network, a Wireless Local Area Network (WLAN), a Local Area Network (LAN), a wireless personal area network (WPAN), a Wireless Local Area Network (WLAN), a wireless wide area network (WWAN), a cloud network, a Long Term Evolution (LTE) network, a plain old telephone service (POTS), and/or a Metropolitan Area Network (MAN). Various devices in the system environment 100 may be configured to connect to the communication network 110, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, such as Long Term Evolution (LTE), Light Fidelity (Li-Fi), and/or other cellular communication protocols or Bluetooth (BT) communication protocols.

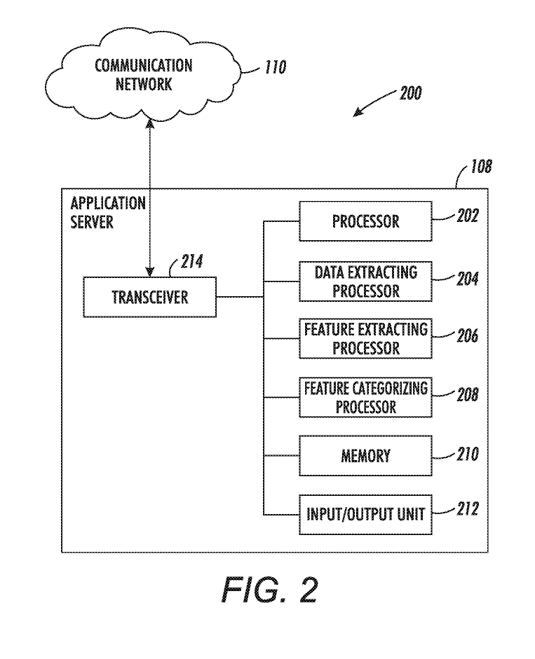

FIG. 2 is a block diagram that illustrates a system for data processing to predict the domain knowledge of the user for the content recommendation, in accordance with at least one embodiment. With reference to FIG. 2, there is shown a system 200 that may include one or more processors, such as a processor 202, one or more data extracting processors, such as a data extracting processor 204, one or more feature extracting processors, such as a feature extracting processor 206, one or more feature categorizing processors, such as a feature categorizing processor 208, one or more memory units, such as a memory 210, one or more input/output (I/O) units, such as an I/O unit 212, and one or more transceivers, such as a transceiver 214.

The system 200 may correspond to a computing device, such as the requestor-computing device 102, or a computing server, such as the application server 108, without departing from the scope of the disclosure. However, for the purpose of the ongoing description, the system 200 corresponds to the application server 108.

The processor 202 comprises suitable logic, circuitry, interfaces, and/or code that may be configured to execute one or more sets of instructions, programs, or algorithms stored in the memory 210 to perform the one or more operations. For example, the processor 202 may be configured to determine the weight of each feature in each set of the extracted set of feature. Further, the processor 202 may be configured to determine the average weight associated with each set of the extracted set of features in each category. Further, the processor 202 may be configured to render the GUI on the display screen of the requestor-computing device 102 or the user-computing device 104 over the communication network 110. The rendered GUI may be configured to display the one or more of, but not limited to, the domain knowledge of the user and the recommended content. In an embodiment, the processor 202 may be communicatively coupled to the data extracting processor 204, the feature extracting processor 206, the feature categorizing processor 208, the memory 210, the I/O unit 212, and the transceiver 214. The processor 202 may be implemented based on a number of processor technologies known in the art. Examples of the processor 202 may include, but not limited to, an X86-based processor, a Reduced Instruction Set Computing (RISC) processor, an Application-Specific Integrated Circuit (ASIC) processor, and a Complex Instruction Set Computing (CISC) processor.

The data extracting processor 204 comprises suitable logic, circuitry, interfaces, and/or code that may be configured to execute one or more sets of instructions, programs, or algorithms stored in the memory 210 to perform the one or more operations. For example, the data extracting processor 204 may be configured to extract the user data from the database server 106. The extraction of the user data may be limited to a time duration, for example, “30 minutes,” “1 hour,” “10 hours,” “1 day,” “1 month,” or “1 year,” as defined by the individual, such as the requestor or the content provider. In an embodiment, the data extracting processor 204 may be communicatively coupled to the processor 202, the feature extracting processor 206, the feature categorizing processor 208, the memory 210, the I/O unit 212, and the transceiver 214. The data extracting processor 204 may be implemented based on a number of processor technologies known in the art. For examples, the data extracting processor 204 may be implemented using one or more of, but not limited to, an X86-based processor, a Reduced Instruction Set Computing (RISC) processor, an Application-Specific Integrated Circuit (ASIC) processor, a Complex Instruction Set Computing (CISC) processor, and/or other processor. Examples of data extracting processor 204 may include, but not limited to PTC® Arbotext, Adobe® Framemaker, LyX®, and/or BroadVision QuickSilver®.

The feature extracting processor 206 comprises suitable logic, circuitry, interfaces, and/or code that may be configured to execute one or more sets of instructions, programs, or algorithms stored in the memory 210 to perform the one or more operations. For example, the feature extracting processor 206 may be configured to extract the set of features from the extracted user data. The extracted set of features may comprise one or more sets of features, for example, a set of keyword features, a set of interest features, a set of profile features, and a set of proficiency features. The feature extracting processor 206 may be communicatively coupled to the processor 202, the data extracting processor 204, the feature categorizing processor 208, the memory 210, the I/O unit 212, and the transceiver 214. The feature extracting processor 206 may be implemented based on a number of processor technologies known in the art. For example, the feature extracting processor 206 may be implemented using one or more of, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

The feature categorizing processor 208 comprises suitable logic, circuitry, interfaces, and/or code that may be configured to execute one or more sets of instructions, programs, or algorithms stored in the memory 210 to perform the one or more operations. For example, the feature categorizing processor 208 may be configured to categorize each feature in the extracted set of features into one of the plurality of categories. The feature categorizing processor 208 may be communicatively coupled to the processor 202, the data extracting processor 204, the feature extracting processor 206, the memory 210, the I/O unit 212, and the transceiver 214. The feature categorizing processor 208 may be implemented based on a number of processor technologies known in the art. For example, the feature categorizing processor 208 may be implemented using one or more of, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

The memory 210 may be operable to store one or more machine code, and/or computer programs having at least one code section executable by the processor 202, the data extracting processor 204, the feature extracting processor 206, the feature categorizing processor 208, the I/O unit 212, and/or the transceiver 214. The memory 210 may store one or more sets of instructions, programs, code, or algorithms that are executed by the processor 202, the data extracting processor 204, the feature extracting processor 206, the feature categorizing processor 208, the I/O unit 212, and/or the transceiver 214 to perform the respective one or more operations. In an embodiment, the memory 210 may comprise one or more buffer units (not shown) that may be configured to store the extracted user data received from the storage device, such as the database server 106. Further, the one or more buffers in the memory 210 may be configured to store the content of the one or more products and/or services that are recommended to the user based on the determined domain knowledge. Some of the commonly known memory implementations include, but are not limited to, a random access memory (RAM), a read-only memory (ROM), a hard disk drive (HDD), and a secure digital (SD) card. In an embodiment, the memory 210 may include the one or more machine code and/or computer programs that are executable by the processor 202, the data extracting processor 204, the feature extracting processor 206, the feature categorizing processor 208, the I/O unit 212, and/or the transceiver 214 to perform the one or more specific operations. It will be apparent to a person having ordinary skill in the art that the one or more instructions stored in the memory 210 enables the hardware of the system 200 to perform the one or more operations.

The I/O unit 212 comprises suitable logic, circuitry, interfaces, and/or code that may be operable to facilitate the individual, such as the content provider or the requestor, to input one or more pre-defined parameters or constraints. For example, the requestor may utilize the I/O unit 212 to define the threshold range of each of the plurality of categories, a pre-defined time duration, and one or more pre-defined threshold values. The requestor may further utilize the I/O unit 212 to provide, as an input, his/her preference and the corresponding one or more preference weight values for each set in the extracted set of features. The I/O unit 212 may be operable to communicate with the processor 202, the data extracting processor 204, the feature extracting processor 206, the feature categorizing processor 208, the memory 210, and/or the transceiver 214. Further, in an embodiment, the I/O unit 212, in conjunction with the processor 202 and the transceiver 214, may be operable to provide the content recommendation to the user based on the determined domain knowledge of the user. In an embodiment, the content recommendation may be either in an audio form, a video form, a graphical form, or a text form. Examples of the input devices may include, but are not limited to, a touch screen, a keyboard, a mouse, a joystick, a microphone, a camera, a motion sensor, a light sensor, and/or a docking station. Examples of the output devices may include, but are not limited to, a speaker system and a display screen.

The transceiver 214 comprises suitable logic, circuitry, interfaces, and/or code that may be configured to receive/transmit the one or more queries, user data, content, or other information from/to one or more computing devices or servers (e.g., the requestor-computing device 102, the user-computing device 104, the database server 106, or the application server 108) over the communication network 110. The transceiver 214 may implement one or more known technologies to support wired or wireless communication with the communication network 110. In an embodiment, the transceiver 214 may include circuitry, such as, but not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 214 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Light Fidelity (Li-Fi), Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

FIG. 3 is a flowchart that illustrates a method for data processing to predict the domain knowledge of the user for the content recommendation, in accordance with at least one embodiment. With reference to FIG. 3, there is shown a flowchart 300 that is described in conjunction with FIG. 1 and FIG. 2. The method starts at step 302 and proceeds to step 304.

At step 304, the request is received from the requestor-computing device 102 over the communication network 110. In an embodiment, the processor 202, in conjunction with the transceiver 214, may be configured to receive the request from the requestor-computing device 102 over the communication network 110. The received request may correspond to the recommendation of the content to the user (or more than one users) based on the degree of domain knowledge associated with the user (or the more than one users).

In an embodiment, the requestor may utilize the requestor-computing device 102 to transmit the request and the associated information to the transceiver 214 over the communication network 110. After receiving the request, the processor 202, in conjunction with the transceiver 214, may store the received request and the associated information in the storage device, such as the memory 210 or the database server 106. The received request may comprise at least the information about the domain-of-interest of the requestor. For example, the domain-of-interest may correspond to “diabetes.” Further, the received request may comprise the preference of the requestor for each of the set of features that are required to be extracted from the user data. The received request may further comprise the one or more preference weights corresponding to the preference for each of the set of features. Further, the received request may comprise the information associated with the plurality of categories. For example, the requestor may specify a count of categories in the plurality of categories. In an exemplary scenario, the count of categories may correspond to “3” and hence, the plurality of categories may comprise the first category, the second category, and the third category. In an embodiment, the first category may correspond to a low literacy category. In an embodiment, the second category may correspond to a medium literacy category. In an embodiment, the third category may correspond to a high literacy category. Further, the requestor may specify the pre-defined threshold range (i.e., a lower threshold value and an upper threshold value) associated with each of the plurality of categories. In an embodiment, a sum of all lower threshold values (or all upper threshold values) associated with the plurality of categories must be “1.” For example, the pre-defined threshold range of the first category may correspond to (0.1, 0.3]. Similarly, the pre-defined threshold range of the second category may correspond to (0.3, 0.6]. Similarly, the pre-defined threshold range of the third category may correspond to (0.6, 1].

A person having ordinary skill in the art will understand that the threshold range of the first category, the second category, and the third category, as defined above, is for illustrative purpose and should be construed as limiting to the scope of the disclosure.

Further, the requestor may further define a time duration in the request. The pre-defined time duration may be utilized by the processor 202 to limit the extraction of the user data. For example, the processor 202 may extract the user data that is associated with the pre-defined time duration. The received request may further comprise the one or more pre-defined threshold values that may be utilized to determine the domain literacy weight of the user. Further, in an embodiment, the requestor may provide the domain dictionary comprising a set of pre-defined features associated with the domain-of-interest. The domain dictionary further includes a pre-defined weight corresponding to each pre-defined feature in the set of pre-defined features. Further, the pre-defined weight of each pre-defined feature in the set of pre-defined features may vary between a range, such as [0.1, 1], as defined by the requestor or a subject matter expert. The set of pre-defined features may comprise one or more sets of, but not limited to, a set of pre-defined keywords, a set of pre-defined interests, a set of pre-defined profiles, and a set of pre-defined proficiencies. In an embodiment, an individual, such as the requestor or the subject matter expert, may prepare or build the domain dictionary. In another embodiment, the requestor may utilize a crowdsourcing platform, such as Amazon Mechanical Turk, to crowdsource the task of preparing or building the domain dictionary. Table 1 shows an exemplary domain dictionary for the domain-of-interest “diabetes.”

TABLE 1
Exemplary Domain Dictionary for “Diabetes”

| Key Features | Weight | Type |
|---|---|---|
| Insulin | 0.5 | Keyword |
| Glucose | 0.2 | Keyword |
| Hypoglycemia | 0.9 | Keyword |
| Obesity | 0.4 | Keyword |
| Diet | 0.1 | Keyword |
| Heart disease | 0.25 | Keyword |
| Blueberry & Blackberry | 0.4 | Interest |
| Ice creams | 0.1 | Interest |
| Carrots & Beans | 0.8 | Interest |
| Travel | 0.5 | Interest |
| Doctor | 0.6 | Profession |
| Nurse | 0.4 | Profession |
| Clinical research in | 1.0 | Specialist/Education |
| diabetes 2 | | |
| Diabetes genetics | 1.0 | Specialist/Education |
| Friends/Followers(0-1) | 0.25 | Friends |
| Friends/Followers(1-5) | 0.5 | Friends |
| Friends/Followers(>5) | 0.7 | Friends |

At step 306, the user data is extracted from the storage device based on at least the received request. In an embodiment, the data extracting processor 204 may be configured to extract the user data of the user from the storage device, such as the database server 106, based on at least the received request.

Prior to the extraction of the user data, in an embodiment, the data extracting processor 204 may be configured to generate a data extraction query based on the information provided by the requestor in the received request. For example, the data extraction query may be generated based on one or more of, but not limited to, the domain-of-interest, the domain dictionary, and the pre-defined time period. Thereafter, the data extracting processor 204, in conjunction with the transceiver 214, may transmit the generated data extraction query to the database server 106 to extract the user data of the user. The database server 106 may be communicatively coupled with the one or more social media platforms, such as the social media platform 106A, and the one or more web search engines, such as the web search engine 106B. Based on the generated data extraction query, the database server 106 may extract the social media data of the user from the social media platform 106A. For example, the extracted social media data may comprise the one or more messages, images, or videos that are posted, shared, liked, disliked, tweeted, or re-tweeted by the user and/or by other users. Further, the extracted social media data may comprise the profile information (personal as well as professional) of the user and his/her likes or dislikes with respect to food, travel, health, and/or the like. The extracted social media data may further comprise a count of follower friends, a count of following friends, and/or the like. Further, in an embodiment, the database server 106 may extract the browsing data of the user from the web search engine 106B based on the generated data extraction query. For example, the extracted browsing data may comprise the information associated with the one or more products and/or services that the user may have queried over the web search engine 106B. In an embodiment, the extracted social media data and/or the extracted browsing data of the user may constitute the extracted user data. After extracting the user data, the database server 106 may transmit the extracted user data to the transceiver 214 over the communication network 110. In another embodiment, the data extracting processor 204 may query the social media platform 106A and/or the web search engine 106B by use of the generated data extraction query to extract the social media data and/or the browsing data of the user that constitute the user data. After extracting the user data, the data extracting processor 204, in conjunction with the transceiver 214, may store the extracted user data in the storage device, such as the memory 210 or the database server 106.

At step 308, the set of features is extracted from the extracted user data. In an embodiment, the feature extracting processor 206 may be configured to extract the set of features from the extracted user data. In an embodiment, the feature extracting processor 206 may be configured to extract the set of features from the extracted user data based on the domain-of-interest. Further, the feature extracting processor 206 may be configured to extract the set of features from the extracted user data by use of the domain dictionary of the domain-of-interest.

In an embodiment, the extracted user data may comprise one or more of the set of keyword features, the set of interest features, the set of profile features, and the set of proficiency features. In an embodiment, the feature extracting processor 206 may extract the set of keyword features based on the one or more messages posted, shared, commented, tweeted, and/or re-tweeted by the user. The feature extracting processor 206 may be configured to remove noise data, if any, from the one or more messages to filter the one or more messages. Thereafter, the feature extracting processor 206 may run one or more text analytics techniques, such as text mining, stemming, building document term matrix, on the filtered one or more messages against the domain dictionary (type=“keyword”) and/or the context in the domain-of-interest to extract the set of keyword features.

Further, in an embodiment, the feature extracting processor 206 may extract the set of interest features based on the likes, dislikes, interests, shares, most visits, links, and profile and preference information that are available in the extracted social media data. In one embodiment, the feature extracting processor 206 may extract the user interests, likes, shares, and/or re-tweets from the extracted social media data based on the domain dictionary (type=“interest”) and/or the context in the domain-of-interest to determine the set of interest features. In another embodiment, the feature extracting processor 206 may extract summary data (using summary extraction algorithms) of the links or uniform resource locator (URL) available in the one or more messages (that may have been posted, tweeted, shared, liked, or disliked by the user) and/or the profile information of the user. Thereafter, the feature extracting processor 206 may be configured to run a keyword pattern analysis on the extracted summary (type=“keywords”) to determine the set of interest features in the link or URL.

Further, in an embodiment, the feature extracting processor 206 may extract the set of profile features from the profile information of the user based on a count of friends, a count of followers, and a count of followings that are associated with the domain-of-interest. Further, in an embodiment, the feature extracting processor 206 may determine the set of proficiency features based on the professional information and specialization information of the user. The feature extracting processor 206 may further determine the set of proficiency features based on a paper or document publication and/or patents filed by the user. After extracting the set of features that includes one or more of the set of keyword features, the set of interest features, the set of profile features, and the set of proficiency features, the feature extracting processor 206, in conjunction with the transceiver 214, may store the extracted set of features in the storage device, such as the memory 210 or the database server 106.

At step 310, the weight of each feature in each set of the extracted set of features is determined based on at least the domain dictionary associated with the domain-of-interest. In an embodiment, the processor 202 may be configured to determine the weight of each feature in each set of the extracted set of features based on at least the domain dictionary associated with the domain-of-interest. In an embodiment, the processor 202 may determine the weight based on at least a comparison of one or more pre-defined features and their corresponding types in the domain dictionary with one or more extracted features and their corresponding types in the extracted set of features. In a scenario where the processor 202 determines that a pre-defined feature (e.g., “insulin”) of a type (e.g., “keyword”) having a pre-defined weight (e.g., “0.5”) in the domain dictionary is matched with an extracted feature in the extracted set of features, then the processor 202 may determine the weight of the extracted feature as “0.5.” Based on such comparison, in an embodiment, the processor 202 may determine the weight of each remaining feature in each set of the extracted set of features, i.e., the set of keyword features, the set of interest features, the set of profile features, and the set of proficiency features. Further, the processor 202 may store the determined weight of each feature in each set of the extracted set of features in the storage device, such as the memory 210 or the database server 106.

After determining the weight of each feature in each set of the extracted set of features, the feature categorizing processor 208 may be configured to categorize each feature into one of the plurality of categories. The plurality of categories may comprise at least the first category (i.e., the low literacy category), the second category (i.e., the medium literacy category), and the third category (i.e., the high literacy category). Further, each of the plurality of categories is associated with the pre-defined threshold range. For example, the pre-defined threshold range of the first category correspond to (0.1, 0.3]. The pre-defined threshold range of the second category correspond to (0.3, 0.6]. The pre-defined threshold range of the third category correspond to (0.6, 1].

In an embodiment, the feature categorizing processor 208 may categorize each feature in each set of the extracted set of features into one of the first category, the second category, and the third category based on at least the weight determined for each feature in each set of the extracted set of features. The feature categorizing processor 208 may categorize each feature into one of the first category, the second category, and the third category based on at least a comparison of the determined weight of each feature with the pre-defined threshold range of each of the first category, the second category, and the third category. For example, the determined weight of an extracted feature (e.g., “blueberry and blackberry”) of a type (e.g., “interest”) is “0.4.” The determined weight of the extracted feature lie between the pre-defined threshold range (0.3, 0.6]. In such a case, the feature categorizing processor 208 may categorize the extracted feature (e.g., “blueberry and blackberry”) of the type (e.g., “interest”) into the second category (i.e., the medium literacy category). Similarly, the feature categorizing processor 208 may categorize each of the remaining features in each set of the extracted set of features into one of the plurality of categories. Table 2 shows an exemplary categorization of features associated with the set of keyword features based on the determined weight.

TABLE 2
Exemplary categorization of keyword features

| | First | Second | Third |
|---|---|---|---|
| Messages | category | category | Category |
| (e.g., post or tweets) | (0.1, 0.3] | (0.3, 0.6] | (0.6, 1] |
| Laughter is the best | | insulin: 0.5 | |
| medicine. Unless you have | | | |
| diabetes, in which case | | | |
| insulin works best | | | |
| Insulin carries glucose into | glucose: | insulin: 0.5 | hypoglycemia: |
| the cell. Any time you give | 0.2 | obesity: 0.4 | 0.9 |
| IV insulin, worry about | | | |
| hypoglycemia #obesity | | | |

Table 3 and Table 4 show an exemplary categorization of features associated with the set of interest features into one of the first category, the second category, and the third category based on the determined weight.

TABLE 3
Exemplary categorization of interest features

| | | First | Second | Third |
|---|---|---|---|---|
| | | category | category | category |
| Interest | Name | (0.1, 0.3] | (0.3, 0.6] | (0.6, 1] |

| | | | |
|---|---|---|---|
| Vegetables | Carrot, Beans, | Potato: 0.2 | Carrot: 0.8 |
| | Potato | | Beans: 0.8 |
| Book | Book of the | 0.1 | |
| | anatomy | | |

TABLE 4
Exemplary categorization of interest features

| | | First | Second | Third |
|---|---|---|---|---|
| | | category | category | category |
| URL/Links | Extracted Summary | (0.1, 0.3] | (0.3, 0.6] | (0.6, 1] |

| | | | |
|---|---|---|---|
| http://link1 | To understand why insulin is | glucose: | insulin: |
| | important in diabetes, it helps to | 0.2 | 0.5 |
| | know more about how the body | | |
| | uses food for energy. Your body is | | |
| | made up of millions of cells. To | | |
| | make energy, these cells need | | |
| | food in a very simple form. When | | |
| | you eat or drink, much of your | | |
| | food is broken down into a simple | | |
| | sugar called “glucose.” Then, | | |
| | glucose is transported through | | |
| | the bloodstream to the cells of | | |
| | your body where it can be used to | | |
| | provide some of the energy your | | |
| | body needs for daily activities. | | |

Table 5 shows an exemplary categorization of features associated with the set of profile features into one of the first category, the second category, and the third category based on the determined weight.

TABLE 5
Exemplary categorization of profile features

| | | First | Second | Third |
|---|---|---|---|---|
| | | category | category | category |
| Name | Count | (0.1, 0.3] | (0.3, 0.6] | (0.6, 1] |
| Facebook friends | 2 | | 0.5 | |
| Twitter followers | 0 | 0.25 | | |
| Twitter followings | 6 | | | 0.7 |

Table 6 shows an exemplary categorization of features associated with the set of proficiency features into one of the first category, the second category, and the third category based on the determined weight.

TABLE 6
Exemplary categorization of proficiency features

| | First | Second | Third |
|---|---|---|---|
| Name of | category | category | category |
| specialization | (0.1, 0.3] | (0.3, 0.6] | (0.6, 1] |
| Software developer | | | |

At step 312, the average weight of each category for each set of the extracted set of features is determined based on at least the determined weight of each feature in each set of the extracted set of features. In an embodiment, the processor 202 may be configured to determine the average weight of each category for each set of the extracted set of features based on at least the determined weight of each feature in each set of the extracted set of features associated with each category. The average weight of each category is determined based on a count of extracted features in each category and the determined weight of each of the count of extracted features. In an exemplary scenario, the processor 202 may utilize the following equation (denoted by equation-1) to determine the average weight:

$$Average weight of a category = \frac{{\sum }_{i = 0}^{last word} weight ( i )}{N} \qquad ( 1 )$$

where,

i: corresponds to i^{th} word in a category; and

N: corresponds to a count of extracted keywords in the category.

For example, Table 7 shows an average keyword weight of each category for the set of keyword features.

TABLE 7
Exemplary determination of average keyword weights of each category

| | First | Second | Third |
|---|---|---|---|
| Messages | category | category | category |
| (e.g., post or tweets) | (0.1, 0.3] | (0.3, 0.6] | (0.6, 1] |
| Laughter is the best medicine. | | insulin: 0.5 | |
| Unless you have diabetes, in | | | |
| which case insulin works best | | | |
| Insulin carries glucose into the | glucose: 0.2 | insulin: 0.5 | hypoglycemia: |
| cell. Any time you give IV | | obesity: 0.4 | 0.9 |
| insulin, worry about | | | |
| hypoglycemia #obesity | | | |
| Average Keyword weight | 0.2 | 0.45 | 0.9 |
| (AKW) | | | |

In another example, Table 8 and Table 9 show an average interest weight of each category for the set of interest features.

TABLE 8
Exemplary determination of average interest weights of each category

| | | First | Second | Third |
|---|---|---|---|---|
| | | category | category | category |
| Interest | Name | (0.1, 0.3] | (0.3, 0.6] | (0.6, 1] |
| Vegetables | Carrot, Beans, | Potato: 0.2 | | Carrot: 0.8 |
| | Potato | | | Beans: 0.8 |
| Book | Book of the | 0.1 | | |
| | anatomy | | | |

| | | | |
|---|---|---|---|
| Average Interest weight-1 | 0.15 | 0.0 | 0.8 |
| (AIW-1) | | | |

TABLE 9
Exemplary determination of average interest weights of each category

| | | First | Second | Third |
|---|---|---|---|---|
| URL/ | | category | category | category |
| Links | Extracted Summary | (0.1, 0.3] | (0.3, 0.6] | (0.6, 1] |
| http:// | To understand why insulin is | glucose: | insulin: | |
| link1 | important in diabetes, it helps | 0.2 | 0.5 | |
| | to know more about how the | | | |
| | body uses food for energy. | | | |
| | Your body is made up of | | | |
| | millions of cells. To make | | | |
| | energy, these cells need food in | | | |
| | a very simple form. When you | | | |
| | eat or drink, much of your food | | | |
| | is broken down into a simple | | | |
| | sugar called “glucose.” Then, | | | |
| | glucose is transported through | | | |
| | the bloodstream to the cells of | | | |
| | your body where it can be used | | | |
| | to provide some of the energy | | | |
| | your body needs for daily | | | |
| | activities. | | | |

| | | | |
|---|---|---|---|
| Average Interest weight-2 (AIW-2) | 0.2 | 0.5 | 0.0 |
| Average Interest weight-1 (AIW-1) | 0.15 | 0.0 | 0.8 |
| Average Interest weight (AIW) | 0.175 | 0.5 | 0.8 |

In another example, Table 10 show an average profile weight of each category for the set of profile features.

TABLE 10
Exemplary determination of average profile weights of each category

| | | First | Second | Third |
|---|---|---|---|---|
| | | category | category | category |
| Name | Count | (0.1, 0.3] | (0.3, 0.6] | (0.6, 1] |
| Facebook friends | 2 | | 0.5 | |
| Twitter followers | 0 | 0.25 | | |
| Twitter followings | 6 | | | 0.7 |

| | | | |
|---|---|---|---|
| Average User Profile weight | 0.25 | 0.5 | 0.7 |
| (AUPW) | | | |

In another example, Table 11 show an average proficiency weight of each category for the set of proficiency features.

TABLE 11
Exemplary determination of average proficiency
weights of each category

| | First | Second | Third |
|---|---|---|---|
| | category | category | category |
| Name of specialization | (0.1, 0.3] | (0.3, 0.6] | (0.6, 1] |
| Software developer | | | |
| Average Proficiency weight | 0.0 | 0.0 | 0.0 |
| (APW) | | | |

At step 314, the domain literacy weight of the user for each category is determined based on at least the determined average weight of each category associated with each set of the extracted set of features. In an embodiment, the processor 202 may be further configured to determine the domain literacy weight of the user for each category based on at least the determined average weight of each category associated with each set of the extracted set of features. In an exemplary scenario, the processor 202 may utilize the following equation (denoted by equation-2) to determine the domain literacy weight of the user for each category:

DLW=(a*AKW^{m1})+(b*AIW^{m2})+(c*AUPW^{m3})+(d*APW^{m4}) (2)

where,

DLW: corresponds to domain literacy weight of a user;

a, b, c, and d: correspond to preference weights of requestor for preferences over one or more sets of an extracted set of features and values of the preference weights lie between 0 and 1; and

m1, m2, m3, and m4: correspond to pre-defined threshold values and values of the pre-defined threshold values are greater than 0.

In an exemplary scenario, Table 12 shows the domain literacy weight of the user for each of the first category, the second category, and the third category. Further, in the exemplary scenario, a value of each of a, b, c, and d and m1, m2, m3, and m4 has been taken as “1” to simplify calculation of the domain literacy weight.

TABLE 12
Exemplary determination
of domain literacy weight of user for each category

| | First | Second | Third |
|---|---|---|---|
| Average Weights | category | category | category |
| Average Keyword weight | 0.2 | 0.45 | 0.9 |
| (AKW) | | | |
| Average Interest weight | 0.175 | 0.5 | 0.8 |
| (AIW) | | | |
| Average User Profile weight | 0.25 | 0.5 | 0.7 |
| (AUPW) | | | |
| Average Proficiency weight | 0.0 | 0.0 | 0.0 |
| (APW) | | | |
| Domain Literacy Weight | 0.625 | 1.45 | 2.4 |
| (DLW) | | | |

After determining the domain literacy weight of the user for each category, the processor 202 may store the domain literacy weight of the user for each category in the storage device, such as the memory 210 or the database server 106.

At step 316, the domain knowledge of the user is predicted based on at least the determined domain literacy weight associated with each category. In an embodiment, the processor 202 may be further configured to predict the domain knowledge of the user based on at least the determined domain literacy weight associated with each category.

Prior to the prediction of the domain knowledge of the user, the processor 202 may be configured to determine a maximum weight of each category in the plurality of categories. In an embodiment, the processor 202 may determine the maximum weight of each category in the plurality of categories based on at least a count of sets in the extracted set of features and the upper threshold value that corresponds to the pre-defined threshold range of each category. For example, with respect to ongoing exemplary scenario, the count of sets in the extracted set of features is “4,” i.e., the set of keyword features, the set of interest features, the set of profile features, and the set of proficiency features. Further, the upper threshold value of each of the first category, the second category, and the third category is “0.3,” “0.6,” and “1.0,” respectively. Therefore, the processor 202 may determine the maximum weight of the first category (MWFC) as “1.2” (i.e., “4*0.3”). Similarly, the processor 202 may determine the maximum weight of the second category (MWSC) as “2.4” (i.e., “4*0.6”). Similarly, the processor 202 may determine the maximum weight of the third category (MWTC) as “4.0” (i.e., “4*1.0”).

After determining the maximum weight of each category in the plurality of categories, the processor 202 may be further configured to determine an occupancy of the determined domain literacy weight for each category. In an embodiment, the processor 202 may determine the occupancy of the determined domain literacy weight for each category based on at least the determined domain literacy weight and the determined maximum weight associated with each category. In an embodiment, the processor 202 may utilize the following equation (denoted by equation-3) to determine the percentage occupancy of the determined domain literacy weight in the first category:

$$PO\_DLW \_FC = \frac{domain literacy weight of user in first category}{maximum weight of first category ( MWFC )} ⋆ 100 \qquad ( 3 )$$

where,

PO_DLW_FC: corresponds to a percentage occupancy of the domain literacy weight in the first category.

Similarly, the processor 202 may utilize the following equation (denoted by equation-4) to determine the percentage occupancy of the determined domain literacy weight in the second category:

$$PO\_DLW \_SC = \frac{domain literacy weight of user in second category}{maximum weight of second category ( MWSC )} ⋆ 100 \qquad ( 4 )$$

where,

PO_DLW_SC: corresponds to a percentage occupancy of the domain literacy weight in the second category.

Similarly, the processor 202 may utilize the following equation (denoted by equation-5) to determine the percentage occupancy of the determined domain literacy weight in the third category:

$$PO\_DLW \_TC = \frac{domain literacy weight of user in third category}{maximum weight of third category ( MWTC )} ⋆ 100 \qquad ( 5 )$$

where,

PO_DLW_TC: corresponds to a percentage occupancy of the domain literacy weight in the third category.

With respect to ongoing example, Table 13 shows the percentage occupancy of the determined domain literacy weight in each of the first category, the second category, and the third category.

TABLE 13
Exemplary determination of
percentage occupancy of each categories

| | Percentage of occupancy |
|---|---|
| Categories | of domain literacy weight |
| Third category (High literacy category) | PO_DLW_TC = 60 |
| Second category (Medium literacy category) | PO_DLW_SC = 60.4 |
| First category (Low literacy category) | PO_DLW_FC = 52 |

After determining the percentage occupancy of the determined domain literacy weight in each of the first category, the second category, and the third category, the processor 202 may utilize one or more pre-defined criteria to predict the domain knowledge of the user. Firstly, the processor 202 may select top two weighted categories from the plurality of categories. With respect to the ongoing example, the top two weighted categories are the second category having a percentage occupancy of “60.4” and the third category having percentage occupancy of “60.” Thereafter, the processor 202 may be configured to perform a check to determine whether the percentage occupancies of the selected top two weighted categories are equal or not. In a scenario where the processor 202 determines that the percentage occupancies of the selected top two weighted categories are equal, then the processor 202 may predict the domain knowledge of the user in order of “high”>“medium”>“low.” However, in a scenario where the processor 202 determines that the percentage occupancies of the selected top two weighted categories are not equal, then the processor 202 may be further configured to determine a percentage difference between the selected top two weighted categories. The percentage difference is determined as:

$$percentage difference = \frac{60.4 - 60.0}{( 60.4 + 60.0 ) / 2} ⋆ 100 = 0.67$$

In an embodiment, if the determined percentage difference is equal to or greater than a pre-defined threshold value, for example, “3,” then the domain knowledge of the user corresponds to the top weighted category from the selected top two weighted categories, else the domain knowledge of the user corresponds to the other weighted category from the selected top two weighted categories. With respect to the ongoing example, the determined percentage difference is “0.67” that is less than the pre-defined threshold value, for example, “3.” In such a case, the processor 202 may predict the domain knowledge of the user as “high” that corresponds to the third category, which is the least weighted category in the selected top two weighted categories.

After determining the domain knowledge of the user in the domain-of-interest, the processor 202 may render the GUI, displaying the domain knowledge of the user, on the display screen of the computing devices, such as the requestor-computing device 102. Further, the processor 202 may utilize the domain knowledge of the user for content recommendations to the user. The processor 202 may render the GUI displaying the content recommendation on the display screen of the user-computing device 104. The content recommendation may comprise at least a recommendation of the one or more products and/or services associated with the domain-of-interest. The content recommendation may further comprise the one or more offers, coupons, promos, or discounts associated with the one or more products and/or services. The control passes to the end step 318.

The disclosed embodiments encompass numerous advantages. The disclosure provides a method for data processing to predict domain knowledge of a user for content recommendation. The disclosed method utilizes processed text, expert domain knowledge, the social media data, the browsing data of the user, and statistical weighting techniques to automatically identify the domain knowledge of the user, without user intervention. Based on the identified domain knowledge of the user, an individual, such as the requestor or content provider, may recommend most appropriate targeted content (such as advertisements, informational and educational content) associated with the one or more products and/or services to the user. Thus, the effectiveness of the targeted content may be substantially enhanced. The type of delivery of the targeted content may effectively keep the user interested in the content associated with the one or more products and/or services. In certain scenarios, the targeted content may be automatically altered to suit different literacy levels. The disclosed method may improve user education and content click-through-rates, and further improves level of user engagement with the content recommended by the system. The disclosed method may track the learning curve of the user specific to a domain. Further, the requestor and/or the user may not have to spend a lot of time in manual surveys, hence, saving time and effort at the both ends.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for data processing to predict domain knowledge of a user for content recommendation. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person having ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for data processing to predict domain knowledge of a user for content recommendation, said method comprising:
receiving, by a transceiver at a computing server, a request from a requestor computing device, associated with a requestor, over a communication network, wherein said request comprises at least information about a domain-of-interest of said requestor;
extracting, by a feature extracting processor at said computing server, a set of features from user data, extracted from a storage device based on at least said received request, based on at least said domain-of-interest;
categorizing, by a feature categorizing processor at said computing server, each feature in each set of said extracted set of features into one of a plurality of categories based on at least a weight associated with said each feature in said each set of said extracted set of features;
determining, by a processor at said computing server, a domain literacy weight of said user for each category of said plurality of categories based on at least an average weight associated with said each set of said extracted set of features in said each category; and
predicting, by said processor, said domain knowledge of said user based on at least said determined domain literacy weight associated with said each category, wherein said predicted domain knowledge is utilized for said content recommendation to said user.

2. The method of claim 1, wherein said received request further comprises at least one of a preference of said requestor for said each set of said extracted set of features, one or more preference weights corresponding to said preference, a pre-defined threshold range associated with each of said plurality of categories, a pre-defined time duration, and one or more pre-defined threshold values.

3. The method of claim 1 further comprising receiving, by said transceiver, a domain dictionary associated with said domain-of-interest from said requestor computing device, wherein said domain dictionary comprises at least a set of pre-defined features and a pre-defined weight corresponding to each of said set of pre-defined features, wherein said set of pre-defined features comprises at least a set of pre-defined keywords, a set of pre-defined interests, a set of pre-defined profiles, and a set of pre-defined proficiency.

4. The method of claim 1, wherein said extracted user data comprises at least one of social media data and browsing data, wherein said storage device is communicatively coupled with at least one or more social media platforms and one or more web search engines over said communication network.

5. The method of claim 1, wherein said set of features are further extracted based on at least a domain dictionary associated with said domain-of-interest.

6. The method of claim 5, wherein said each set of said extracted set of features corresponds to at least one of a set of keyword features, a set of interest features, a set of profile features, and a set of proficiency features.

7. The method of claim 1, wherein said weight associated with said each feature in said each set of said extracted set of features is determined, by said processor, based on at least a domain dictionary associated with said domain-of-interest.

8. The method of claim 7, wherein said each feature in said each set of said extracted set of features is categorized into one of said plurality of categories based on at least a comparison of said determined weight of said each feature in said each set of said extracted set of features with a pre-defined threshold range associated with each of said plurality of categories.

9. The method of claim 8, wherein said average weight associated with said each set of said extracted set of features in said each category is determined, by said processor, based on at least said determined weight of said each feature in said each set of said extracted set of features associated with said each category.

10. The method of claim 1 further comprising determining, by said processor, a maximum weight of said each category based on at least a count of sets in said extracted set of features and an upper limit value that correspond to a pre-defined threshold range of said each category.

11. The method of claim 10 further comprising determining, by said processor, an occupancy of said determined domain literacy weight for said each category based on at least said determined domain literacy weight and said determined maximum weight associated with said each category.

12. The method of claim 11, wherein said prediction of said domain knowledge of said user is based on at least a comparison between at least said determined occupancy associated with each of at least top two categories of said plurality of categories.

13. The method of claim 1, wherein said content recommendation comprises at least a recommendation of one or more products and/or services associated with said domain-of-interest to said user.

14. A system for data processing to predict domain knowledge of a user for content recommendation, said system comprising:
a transceiver configured to receive a request from a requestor computing device, associated with a requestor, over a communication network, wherein said request comprises at least information about a domain-of-interest of said requestor;
a feature extracting processor configured to extract a set of features from user data, extracted from a storage device based on at least said received request, based on at least said domain-of-interest;
a feature categorizing processor configured to categorize each feature in each set of said extracted set of features into one of a plurality of categories based on at least a weight associated with said each feature in said each set of said extracted set of features;
a processor configured to:
determine a domain literacy weight of said user for each category of said plurality of categories based on at least an average weight associated with said each set of said extracted set of features in said each category; and
predict said domain knowledge of said user based on at least said determined domain literacy weight associated with said each category, wherein said predicted domain knowledge is utilized for said content recommendation to said user.

15. The system of claim 14, wherein said received request further comprises at least one of a preference of said requestor for said each set of said extracted set of features, one or more preference weights corresponding to said preference, a pre-defined threshold range associated with each of said plurality of categories, a pre-defined time duration, and one or more pre-defined threshold values.

16. The system of claim 14, said transceiver is further configured to receive a domain dictionary associated with said domain-of-interest from said requestor computing device, wherein said domain dictionary comprises at least a set of pre-defined features and a pre-defined weight corresponding to each of said set of pre-defined features, wherein said set of pre-defined features comprises at least a set of pre-defined keywords, a set of pre-defined interests, a set of pre-defined profiles, and a set of pre-defined proficiency.

17. The system of claim 14, wherein said extracted user data comprises at least one of social media data and browsing data, wherein said storage device is communicatively coupled with at least one or more social media platforms and one or more web search engines over said communication network.

18. The system of claim 14, wherein said processor is further configured to extract said set of features based on at least a domain dictionary associated with said domain-of-interest, wherein said each set of said extracted set of features corresponds to at least one of a set of keyword features, a set of interest features, a set of profile features, and a set of proficiency features.

19. The system of claim 14, wherein said processor is further configured to determine said weight associated with said each feature in said each set of said extracted set of features based on at least a domain dictionary associated with said domain-of-interest.

20. The system of claim 19, wherein said feature categorizing processor is configured to categorize said each feature in said each set of said extracted set of features into one of said plurality of categories based on at least a comparison of said determined weight of said each feature in said each set of said extracted set of features with a pre-defined threshold range associated with each of said plurality of categories.

21. The system of claim 20, wherein said processor is further configured to determine said average weight associated with said each set of said extracted set of features in said each category based on at least said determined weight of said each feature in said each set of said extracted set of features associated with said each category.

22. The system of claim 14, wherein said processor is further configured to determine a maximum weight of said each category based on at least a count of sets in said extracted set of features and an upper limit value that correspond to a pre-defined threshold range of said each category.

23. The system of claim 22, wherein said processor is further configured to determine an occupancy of said determined domain literacy weight for said each category based on at least said determined domain literacy weight and said determined maximum weight associated with said each category.

24. The system of claim 23, wherein said prediction of said domain knowledge of said user is based on at least a comparison between at least said determined occupancy associated with each of at least top two categories of said plurality of categories.

25. The system of claim 14, wherein said content recommendation comprises at least a recommendation of one or more products and/or services associated with said domain-of-interest to said user.

26. A computer program product for use with a computer, said computer program product comprising a non-transitory computer readable medium, wherein said non-transitory computer readable medium stores a computer program code for data processing to predict domain knowledge of a user for content recommendation, wherein said computer program code is executable by one or more processors in a computing device to:
receive a request from a requestor computing device, associated with a requestor, over a communication network, wherein said request comprises at least information about a domain-of-interest of said requestor;
extract a set of features from user data, extracted from a storage device based on at least said received request, based on at least said domain-of-interest;
categorize each feature in each set of said extracted set of features into one of a plurality of categories based on at least a weight associated with said each feature in said each set of said extracted set of features;
determine a domain literacy weight of said user for each category of said plurality of categories based on at least an average weight associated with said each set of said extracted set of features in said each category; and
predict said domain knowledge of said user based on at least said determined domain literacy weight associated with said each category, wherein said predicted domain knowledge is utilized for said content recommendation to said user.
